(19) United States
(12) Patent Application Publication
(10) Pub. No.: US 2007/0098392 A1
(43) Pub. Date: May 3, 2007

(54) Slave strobe

(76) Inventors: Theodore B. Ziemkowski, Loveland, CO (US); Donald Stavely, Windsor, CO (US); Andrew C. Goris, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,189

(22) Filed: Oct. 27, 2005

(51) Int. Cl. G03B 15/03

(52) U.S. Cl. 396/171

(57) ABSTRACT

A strobe body including a photodetector, a flash tube, and a flash controller is built with the photodetector configured to detect a flash of light. The flash controller is electrically coupled with the photodetector and the flash tube and is configured to measure the length of the flash of light. The controller then fires the flash tube for a controlled length of time after the flash of light has ended.

### BACKGROUND OF THE INVENTION

There are two types of traditional slave strobes. One is hard-wired (or controlled wirelessly in some examples) to the master device (usually a camera) and fires its strobe when the master signals it to do so. In this configuration, it could be controlled to fire multiple times and could even be told to fire for a particular length of time depending on the control signals received from the master device. One disadvantage for this type of slave strobe is that the master and the slave must be designed to work together, since they both must use the same set of control signals. This limits a family of slave strobes to a particular family of master devices that use the same control signals.

The other traditional slave strobe is one that “looks” for a short pulse of light that is significantly brighter than the ambient light. These slaves fire when they detect a strobe fire from a master device or even from a secondary slave device. This type of slave strobe is very convenient as it does not require a camera with a strobe output (many of the newer pocket cameras do not include a strobe output).

However, neither of these solutions works well for most modern compact cameras, as this type of camera typically does not include a strobe output control, and also often uses pre-flashes either to measure the amount of light needed for a proper exposure or to reduce red eye.

Some slave strobes attempt to overcome these problems by detecting the first flash of light, then waiting a set amount of time (for example 200 ms) before firing the strobe in the hope that this amount of delay will be sufficient to miss most of the pre-flashes and only fire on the final flash. However, many compact cameras use the un-assisted pre-flashes to measure exposure, and when the main flash then fires in addition to the strobe, there will be additional light on the scene which may cause an overexposure of the image.

### SUMMARY OF THE INVENTION

A strobe body including a photodetector, a flash tube, and a flash controller is built with the photodetector configured to detect a flash of light. The flash controller is electrically coupled with the photodetector and the flash tube and is configured to measure the length of the flash of light. The controller then fires the flash tube for a controlled quantity of time after the flash of light has ended.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is a top view of a slave strobe according to an example embodiment of the present invention.

FIG. 1B is a bottom view of the slave strobe from FIG. 1A according to an example embodiment of the present invention.

FIG. 1C is a front view of the slave strobe from FIG. 1A according to an example embodiment of the present invention.

FIG. 1D is a rear view of the slave strobe from FIG. 1A according to an example embodiment of the present invention.

FIG. 1E is a left view of the slave strobe from FIG. 1A according to an example embodiment of the present invention.

FIG. 1F is a right view of the slave strobe from FIG. 1A according to an example embodiment of the present invention.

FIG. 2 is a perspective view of the slave strobe from FIGS. 1A-1F according to an example embodiment of the present invention.

FIG. 3 is a flow chart of an example embodiment of a method for constructing a slave strobe according to the present invention.

FIG. 4A is a timing diagram of an example embodiment of a slave strobe according to an example embodiment of the present invention.

FIG. 4B is a timing diagram of an example embodiment of a slave strobe according to an example embodiment of the present invention.

### DETAILED DESCRIPTION

This description of the preferred embodiments is intended to be read in connection with the accompanying drawings, which are to be considered part of the entire written description of this invention. In the description, relative terms such as “lower,” “upper,” “horizontal,” “vertical,” “up,” “down,” “top,” “bottom,” “left,” and “right” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected,” “coupled,” and “interconnected,” refer to a relationship wherein structures are secured or attached to one another either directly or indirectly through intervening structures, as well as both movable or rigid attachments or relationships, unless expressly described otherwise.

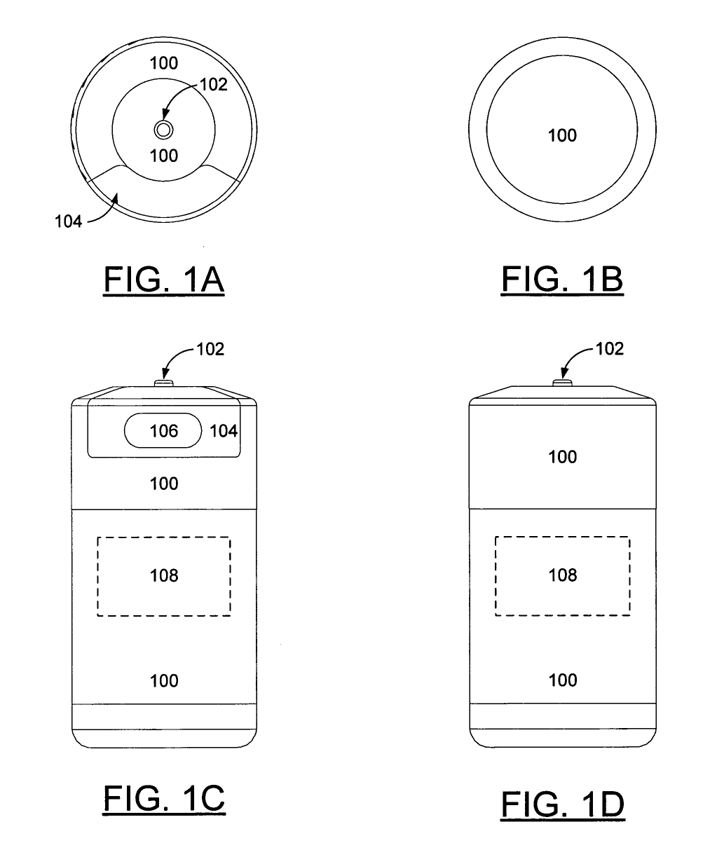

FIG. 1A is a top view of a slave strobe according to an example embodiment of the present invention. In this example embodiment of a slave strobe, a strobe body 100 is built including a photodetector 102, a flash tube 106, an optional flash diffuser 104, and a flash controller 108. The photodetector 102 is configured to sense the ambient light levels and electrically signal to the flash controller 108 the present amount of light detected. The photodetector 102 is electrically coupled with the flash controller 108 which may contain circuitry monitoring the output of the photodetector. Many common photodetectors 102, such as photodiodes, output a signal that is proportional to the amount of light striking the photodetectors 102. This signal is often a voltage, however other embodiments of the present invention may use other types of electrical signals, such as a current, or even as a digital signal. The flash controller 108 receives this signal and detects when the signal rises above a threshold amount (an amount above the current ambient light) signaling that the amount of light has increased. The flash controller 108 then starts a clock to time the length of the flash of light. If the length of time passes a maximum flash time threshold, it is unlikely that the increased amount of light is due to a flash, and the flash controller 108 ignores the increase in ambient light. The flash controller 108 measures the length of the flash of light as a first length of time and then fires the flash tube 106 for a second length of time. In some embodiments of the present invention, the second length of time is substantially equal to the first length of time and in cases where the power of the flash tube 106 in the slave strobe matches the power of the flash tube in the camera, provides proper exposure of the image. In some embodiments of the present invention, the second length of time may differ from the first length of time as a way to control the power of the flash of the slave strobe. For example, the user may desire to use the slave strobe to highlight a small area and thus may set the slave strobe such that the second length of time is a fraction of the first length of time. For example, the slave strobe may have a half power mode where the second length of time is set to one-half of the first length of time. Likewise, in some situations, the slave strobe may be set such that the second length of time is longer that the first length of time. In some example embodiments of the present invention a user may be allowed to select a ratio between the first length of time and the second length of time, while in other embodiments, the ratio between the first length of time and the second length of time may be fixed. Those of skill in the art will recognize that the ratio of the first length of time to the second length of time may be any amount within the scope of the present invention. The desired ration may also be a function of the intensity of the slave strobe and the distance from the slave strobe to the object being illuminated.

Other embodiments of the present invention may include flash tubes 106 with controllable power (such as LCD's). In these embodiments, the intensity of the slave flash may be controlled, along with the length of the slave flash. This additional flexibility may allow the slave strobe to increase in flash intensity where shorter shutter speeds are expected to be used, and decrease intensity for slower shutter speeds. Since the amount of illumination on a scene is proportional to the intensity multiplied by the length of the flash, the flash controller 108 may be configured to vary both intensity and length of the flash to control the resulting illumination.

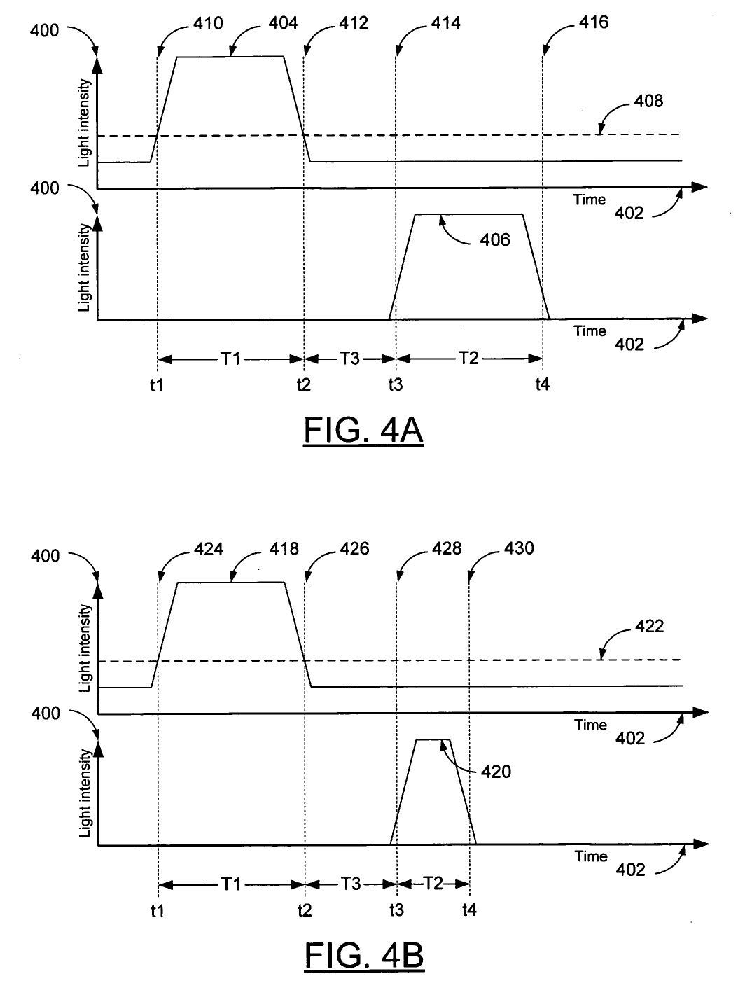

In some example embodiments of the present invention, the flash controller 108 may wait a third length of time before firing the flash tube 106. This allows other slave strobes to catch the initial flash of light without confusing the flash from the slave strobe as part of the initial flash. This third length of time may be any amount within the scope of the present invention. In some embodiments of the present invention this third length of time may be selected by a user, while in other embodiments, it may be a fixed amount. See FIG. 4 for a graphical illustration of these timing events.

FIG. 1B is a bottom view of the slave strobe from FIG. 1A according to an example embodiment of the present invention.

FIG. 1C is a front view of the slave strobe from FIG. 1A according to an example embodiment of the present invention.

FIG. 1D is a rear view of the slave strobe from FIG. 1A according to an example embodiment of the present invention.

FIG. 1E is a left view of the slave strobe from FIG. 1A according to an example embodiment of the present invention.

FIG. 1F is a right view of the slave strobe from FIG. 1A according to an example embodiment of the present invention.

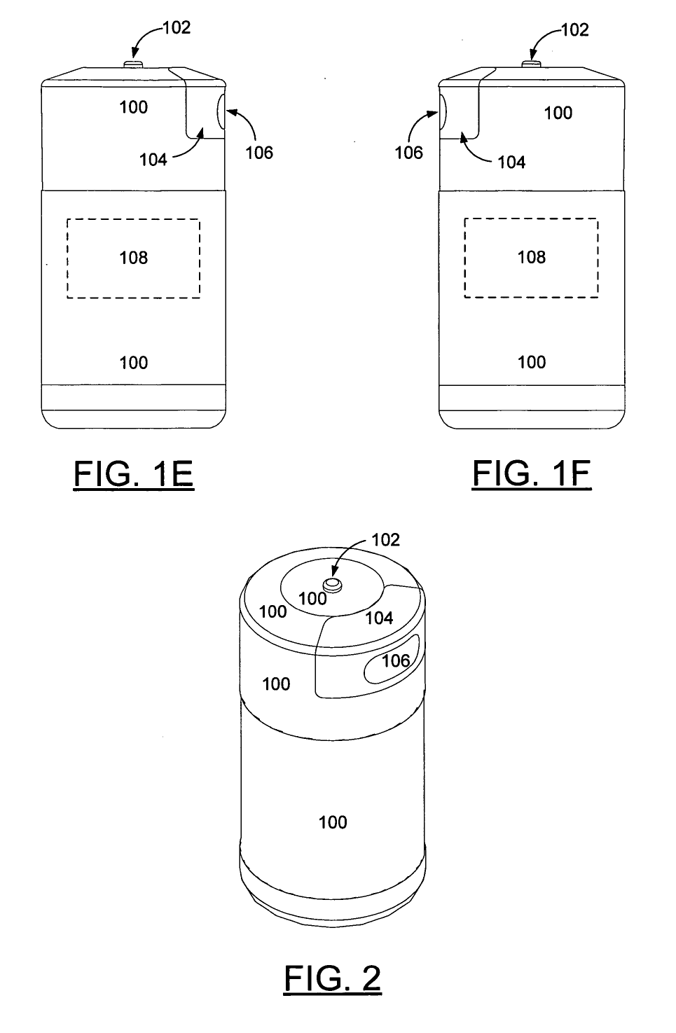

FIG. 2 is a perspective view of the slave strobe from FIGS. 1A-1F according to an example embodiment of the present invention.

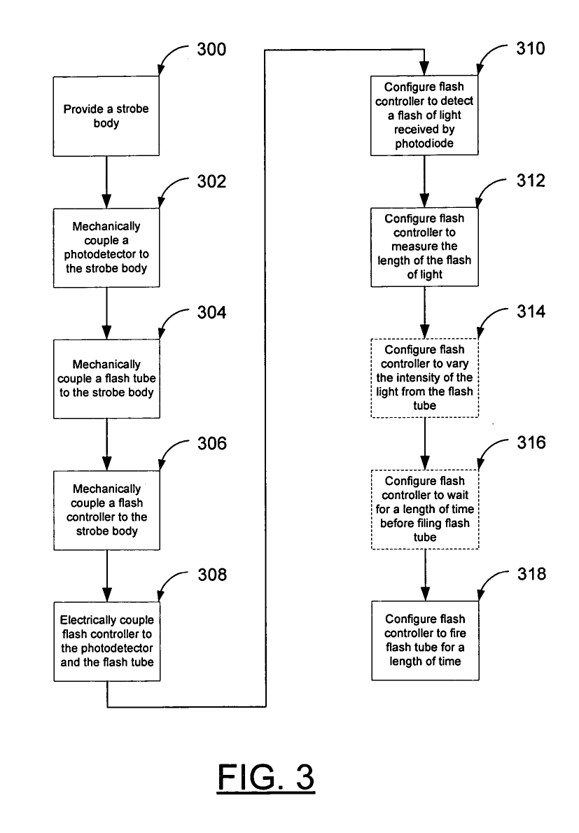

FIG. 3 is a flow chart of an example embodiment of a method for constructing a slave strobe according to the present invention. In a step 300, a strobe body is provided. In a step 302, a photodetector is mechanically coupled to the strobe body. In a step 304, a flash tube is mechanically coupled to the strobe body. In a step 306, a flash controller is mechanically coupled to the strobe body. In a step 308, the flash controller is electrically coupled to the photodetector and the flash tube. In a step 310, the flash controller is configured to detect a flash of light received by the photodiode. In a step 312, the flash controller is configured to measure a length of the flash of light. In an optional step 314, the flash controller is configured to vary the intensity of the light from the flash tube. In an optional step, 316, the flash controller is configured to wait a length of time before firing the flash tube. In a step 318, the flash controller is configured to fire the flash tube for a length of time proportional to the measured length of time of the flash of light.

FIG. 4A is a timing diagram of an example embodiment of a slave strobe according to an example embodiment of the present invention. In all of the timing diagrams of FIGS. 4A and 4B, light intensity 400 is plotted on the y-axis and time 402 is plotted on the x-axis. The upper timing diagram of FIG. 4A represents the light intensity detected by a photodetector plotted against time as the line 404. This light intensity starts at an ambient level and at a time t1 410 the light intensity is seen to exceed a light threshold 408 and rise to a high level before dropping back below the light threshold 408 at a time t2 412. The length of time between t1 410 and 412 is referenced as a first length of time and labeled T1 on the timing diagram. At a time t3 414 the flash tube of the slave strobe fires and the light intensity of the slave strobe 406 is seen to rise to a high level before dropping back to essentially zero at a time t4 416. The length of time between t3 414 and t4 416 is referenced as a second length of time and labeled T2 on the timing diagram. The delay between the detection of the flash of light and the firing of the flash tube is measured between t2 412 and t3 414, and this length of time is referenced as a third length of time and labeled T3 on the timing diagram. Some example embodiments of the present invention may allow a user to select this third length of time, while other embodiments may use a fixed third length of time. Those of skill in the art will recognize that in this example embodiment of the present invention, the first length of time and the second length of time are substantially equal. Other embodiments of the present invention may use any ratio between the first length of time and the second length of time within the scope of the present invention. Some example embodiments of the present invention may allow a user to select the ratio between the first length of time and the second length of time, while other embodiments may use a fixed ratio. Those of skill in the art will recognize that one limitation on the three lengths of time described above, is that all three times must complete before the camera shutter closes, or the full effect of the slave strobe will be lost. Fortunately, in most situations, the flashes last for substantially shorter times than typical shutter speeds using flash illumination. For example, in one embodiment of the present invention, a camera may use a shutter speed of 1/100 sec. while flash speeds are typically on the order of 1/1000 sec. In this example, it is easy to contain two flashes within the shutter speed of the camera, however, this shutter speed does represent an upper limit on the length of the flashes.

FIG. 4B is a timing diagram of an example embodiment of a slave strobe according to an example embodiment of the present invention. In this example embodiment of the present invention, the slave strobe is set to a half power mode, where the slave strobe fires for substantially half of the length of time of the detected flash of light. The upper timing diagram of FIG. 4B represents the light intensity detected by a photodetector plotted against time as the line 418. This light intensity starts at an ambient level and at a time t1 424 the light intensity is seen to exceed a light threshold 422 and rise to a high level before dropping back below the light threshold 422 at a time t2 426. The length of time between t1 424 and 426 is referenced as a first length of time and labeled T1 on the timing diagram. At a time t3 428 the flash tube of the slave strobe fires and the light intensity of the slave strobe 420 is seen to rise to a high level before dropping back to essentially zero at a time t4 430. The length of time between t3 428 and t4 430 is referenced as a second length of time and labeled T2 on the timing diagram. The delay between the detection of the flash of light and the firing of the flash tube is measured between t2 426 and t3 428, and this length of time is referenced as a third length of time and labeled T3 on the timing diagram. Those of skill in the art will recognize that in this example embodiment of the present invention, the second length of time is substantially half of the first length of time. Other embodiments of the present invention may use any ratio between the first length of time and the second length of time within the scope of the present invention.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
a strobe body;
a photodetector mechanically coupled with said strobe body;
a flash tube mechanically coupled with said strobe body; and
a flash controller mechanically coupled with said strobe body, and electrically coupled with said photodetector and said flash tube;
and, wherein said flash controller is configured to detect a flash of light received by said photodetector,
to measure a first length of time corresponding to said flash of light, and
to fire said flash tube for a second length of time after the end of said flash of light.

2. The device recited in claim 1,
wherein said second length of time is substantially equal to said first length of time.

3. The device recited in claim 1,
wherein said second quantity of time is proportional to said first length of time.

4. The device recited in claim 1,
wherein said flash controller is also configured to wait for a third length of time after the end of the flash of light before firing said flash tube.

5. The device recited in claim 1,
wherein the ratio between said first length of time and said second length of time is selectable by a user.

6. The device recited in claim 1,
wherein said third length of time is selectable by a user.

7. The device recited in claim 1, further comprising:
a flash diffuser mechanically coupled with said strobe body, and configured to diffuse at least some of the light emitted from said flash tube.

8. The device recited in claim 1,
wherein said flash controller is also configured to vary an intensity of the light emitted from said flash tube.

9. A method comprising the steps of:
a) providing a strobe body;
b) mechanically coupling a photodetector to the strobe body;
c) mechanically coupling a flash tube to the strobe body;
d) mechanically coupling a flash controller to the strobe body;
e) electrically coupling the flash controller to the photodetector and the flash tube;
f) configuring the flash controller to detect a flash of light received by said photodiode;
g) configuring the flash controller to measure a first length of time corresponding to the length of the flash of light; and
h) configuring the flash controller to fire the flash tube for a second length of time after the end of the flash of light.

10. The method recited in claim 9,
wherein said second length of time is substantially equal to said first length of time.

11. The method recited in claim 9,
wherein said second quantity of time is proportional to said first length of time.

12. The method recited in claim 9, further comprising the step of:
i) configuring said flash controller to wait for a third length of time after the end of the flash of light before firing said flash tube.

13. The method recited in claim 9,
wherein the ratio between said first length of time and said second length of time is selectable by a user.

14. The method recited in claim 9,
wherein said third length of time is selectable by a user.

15. The method recited in claim 9, further comprising the step of:
i) mechanically coupling a flash diffuser with said strobe body, configured to diffuse at least some of the light emitted from said flash tube.

16. The method recited in claim 9, further comprising the step of:
i) configuring said flash controller to vary an intensity of the light emitted from said flash tube.

17. A device comprising:
a body;
means for detecting a first flash of light; and
means for creating a second flash of light;
means for measuring the length of said first flash of light; and
means for controlling said means for creating a second flash of light, such that said second flash of light lasts for a second length of time.

18. The device recited in claim 17,
wherein said second length of time is substantially equal to said first length of time.

19. The device recited in claim 17,
wherein said second quantity of time is proportional to said first length of time.

20. The device recited in claim 17,
wherein said means for controlling is also configured to wait for a third length of time after the end of the flash of light before firing said flash tube.

21. The device recited in claim 17,
wherein the ratio between said first length of time and said second length of time is selectable by a user.

22. The device recited in claim 17,
wherein said third length of time is selectable by a user.

23. The device recited in claim 17, further comprising:
means for diffusing at least some of the light emitted from said flash tube.

24. The device recited in claim 17, further comprising:
means for varying an intensity of the light emitted from said flash tube.
